(19) United States
(12) Patent Application Publication
(10) Pub. No.: US 2009/0170392 A1
(43) Pub. Date: Jul. 2, 2009

(54) COMPOSITE ELEMENT MADE FROM POLYURETHANE AND POLYOLEFIN

(75) Inventors: Bernd Bruchmann, Freinsheim (DE); Hauke Malz, Diepholz (DE); Ulrike Licht, Mannheim (DE); Oliver Hartz, Limburgerhof (DE); Karl-Heinz Schumacher, Neustadt (DE); Andre Burghardt, Dickesbach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/281,347

(22) PCT Filed: Feb. 28, 2007
(86) PCT No.: PCT/EP2007/051867

§ 371 Date: Sep. 2, 2008

(30) Foreign Application Priority Data
Mar. 10, 2006 (EP) 06110923.7

(51) Int. Cl. B32B 27/08

(52) U.S. Cl. 442/351; 428/424.8; 442/398

(57) ABSTRACT

A composited element comprises a substrate composed of a polyolefin and a substrate composed of a polyurethane which are composited together by an adhesive.

Composited elements are elements in which two or more substrates composed of different materials are composited together.

Composited elements are important for a wide variety of uses. Such composited elements frequently composite polymeric films or else polymeric films with fibrous webs.

Fibrous webs are textile fabrics composed of fibers. Non-woven fibrous webs (nonwovens) are particularly important. In such non-woven fibrous webs, the fibers adhere together physically or chemically, for example through use of a binder.

Synthetic polymers are frequently used as fibrous material for nonwovens. Nonwovens are used in the hygiene sector, for example for diapers and disposable flannels, or else in technical/industrial applications, such as filters, in medical/medicinal applications, in structural and civil engineering, in particular as geotextiles and roofing underlayments. Nonwovens based on synthetic polymers are mainly produced in continuous processes. The meltblown and spunbond processes may be mentioned here in particular. In these processes, the polymer is melted in an extruder and pumped to a spinneret die. State of the art spunbond processes operate at high throughputs and utilize spinning manifolds up to 5 m in width for continuous production of the spunbonded nonwovens. Nonwovens can also be produced from staple fibers. The staple fibers having a length in the range from 25 mm to 400 mm but preferably in the range from 40 to 60 mm and a linear density of 3.3-8 dtex are laid down on a belt, either in a parallel arrangement or unsorted, and are subsequently bonded together thermally or chemically.

The use of polypropylene (PP) nonwovens as roofing underlayments is an important and growing market. The porosity of the PP nonwoven ensures very good attic ventilation. However, this also shows up an immense disadvantage of the PP nonwoven. This is because water coming in through a leaky roof will also pass through the porous nonwoven layer. This is why there are attempts to bond PP nonwovens to a film in order that an impervious composite may be obtained in this way. The nonwoven endows this composite with mechanical stability and tear resistance, while the film gives it the desired imperviousness. However, such a composite also has to have the necessary breathability. A composite comprising PP nonwoven and PP film does not qualify because of the low water vapor permeability of the PP for example.

Thermoplastic polyurethanes (TPUs) are polyurethanes having thermoplastic processing properties. Thermoplastic here refers to the polyurethane's property of, in a typical polyurethane temperature range between 150° C. and 300° C., repeatedly softening when hot and hardening when cooled and, in the softened state, repeatedly being moldable into intermediate or final articles by flowing, as a molded, extruded or formed part.

Films composed of thermoplastic polyurethanes based on polyether- and polyesterols have a high monolithic water vapor permeability. This is why TPU films are frequently used wherever water vapor permeability and waterproofness are of importance, for example in functional clothing.

However, PP and TPU differ in character and do not adhere to each other. A composite delaminates apart under minimal loading. The state of the art approach in relation to processes such as injection molding is to hydrophilicize the PP by plasma or corona treatment in order that a bond may be produced in this way. However, a high input of energy is needed to achieve sufficient hydrophilicization. This may cause PP webs to become damaged, particularly when they are of low basis weight.

Nonwovens composed of polypropylene are not elastic. In hygiene applications, for example in diapers, it is therefore necessary to combine polypropylene nonwovens with elastic fibers, for example spandex fibers, in order that the necessary wear comfort may be ensured. This process is complicated and costly, however. It would be better if the nonwoven itself were elastic.

Nonwovens composed of TPU have this desired elasticity. However, it has emerged that when TPU nonwovens are worn next to the human skin for several hours the wear comfort is perceived as rubberily unpleasant. This is why TPU nonwovens are frequently produced in the bicomponent mode. Bicomponent mode refers to a TPU core being enclosed with a polyolefin sheath for example. This gives a smooth nonblocking surface. However, the bicomponent process is very complex and hence costly. Thus, all components of the manufacturing plant are needed in duplicate, i.e., two separate extruders, separate melt lines, pumps, etc. In addition, the spinneret dies are very complex and hence costly.

It would therefore be more advantageous to produce a TPU nonwoven in a composite with a polyolefin nonwoven. The TPU nonwoven would then provide elasticity, and the polyolefin nonwoven the pleasant wear comfort. However, hitherto all attempts in that direction have failed because it has not been possible to produce a bond between the TPU nonwoven and the polyolefin nonwoven.

It is an object of the present invention to provide a composited element which is simple to produce and which has the requisite properties for the particular use. When used as a roofing underlayment, the composited element, or laminate, shall have in particular good mechanical properties coupled with the requisite breathability. The laminate shall be obtainable and usable in an easy and environmentally friendly manner.

We have found that this object is achieved by the composited element defined at the beginning. We have also found uses for the composited elements, including in particular as a roofing underlayment.

The composited element of the present invention comprises a substrate composed of a polyolefin and a substrate composed of a polyurethane which are composited together by an adhesive.

### The Polyurethane

The polyurethane preferably comprises thermoplastic polyurethane (TPU).

Thermoplastic polyurethanes are polyurethanes which on heating to temperatures at which the polyurethane is flowable, for example at temperatures in the range from 150 to 300° C., and cooling remain shapable, i.e., can again be rendered flowable, brought into the desired shape and cooled. In the softened state, the polyurethane can be shaped into any desired shape, extruded or otherwise processed.

TPUs are prepared in particular by reacting diisocyanates with compounds having at least two hydrogen atoms reactive with isocyanate groups, these compounds being preferably difunctional alcohols.

Useful diisocyanates include customary aromatic, aliphatic and/or cycloaliphatic diisocyanates, for example diphenylmethane diisocyanate (MDI), tolylene diisocyanate (TDI), tri-, tetra-, penta-, hexa-, hepta- and/or octamethylene diisocyanates, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate, 4,4′-, 2,4′- and/or 2,2′-dicyclohexylmethane diisocyanate.

Useful isocyanate-reactive compounds include commonly known polyhydroxy compounds having molecular weights in the range from 500 to 8000, preferably in the range from 600 to 6000 and especially in the range from 800 to 4000, and preferably an average functionality in the range from 1.8 to 2.6, preferably 1.9 to 2.2, in particular 2, for example polyesterols, polyetherols and/or polycarbonate diols. Preference for use as (b) is given to polyester diols obtainable by reaction of butanediol and hexanediol as diol with adipic acid as dicarboxylic acid, the weight ratio of butanediol to hexanediol preferably being 2:1. Preference is further given to polytetrahydrofuran having a molecular weight in the range from 750 to 2500 g/mol and preferably in the range from 750 to 1200 g/mol.

Useful chain extenders include commonly known compounds, for example diamines and/or alkanediols having 2 to 10 carbon atoms in the alkylene radical, in particular ethylene glycol and/or 1,4-butanediol and/or hexanediol and/or di- and/or trioxyalkylene glycols having 3 to 8 carbon atoms in the oxyalkylene radical, preferably the corresponding oligo- and/or polyoxypropylene glycols, including mixtures thereof. Useful chain extenders further include 1,4-bis(hydroxymethyl)benzene (1,4-BHMB), 1,4-bis(hydroxyethyl)benzene (1,4-BHEB) or 1,4-bis(2-hydroxyethoxy)benzene (1,4-HQEE). The preferred chain extender is 1,4-butanediol.

It is customary to use catalysts to speed the reaction between the NCO groups of the diisocyanates and the hydroxyl groups of the building block components, examples being tertiary amines, such as triethylamine, dimethylcyclohexylamine, N-methyl-morpholine, N,N′-dimethylpiperazine, 2-(dimethylaminoethoxy)ethanol, diazabicyclo-(2,2,2)-octane and the like, and also in particular organic metal compounds such as titanic esters, iron compounds such as for example iron(III) acetylacetonate, tin compounds, such as tin diacetate, tin dilaurate or the tin dialkyl salts of aliphatic carboxylic acids such as dibutyltin diacetate, dibutyltin dilaurate or the like. Catalysts are typically used in amounts of 0.0001 to 0.1 part by weight per 100 parts by weight of polyhydroxy compound.

As well as catalysts, customary auxiliary materials can also be added to the building block components. Examples of useful auxiliary materials include surface-active substances, flame retardants, nucleating agents, gliding and demolding aids, dyes and pigments, inhibitors, stabilizers against hydrolysis, light, heat, oxidation or discoloration, agents to protect against microbial degradation, inorganic and/or organic fillers, reinforcing agents and plasticizers.

The TPUs are usually produced by customary processes, as by means of belt machines or reactive extruders. Films can likewise be produced from TPU by customary processes, as by extrusion for example.

### The Polyolefin

Useful polyolefins include for example homopolymers of monoolefins or copolymers of monoolefins with other monoolefins, diolefins or with other vinyl monomers.

Specific examples are ethylene-propylene copolymers, linear low density polyethylene (LLDPE) and mixtures thereof with low density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers thereof with carbon monoxide, or ethylene-acrylic acid copolymers and salts thereof (ionomers), and also terpolymers of ethylene with propylene and a diene, such as hexanediene, dicyclopentadiene or ethylidenenorbornene, also mixtures of such copolymers with each other and with the polymers mentioned under 1, for example polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers and alternating or random polyalkylene-carbon monoxide copolymers.

The polyolefin preferably comprises polypropylene.

Polypropylene is to be understood as referring to homopolymers of propylene or propylene copolymers which are at least 50% by weight, in particular at least 70% by weight, more preferably at least 90% by weight, and most preferably at least 95% by weight of propylene.

### The Adhesive

The adhesive preferably comprises a polyurethane adhesive.

Polyurethane adhesive is to be understood as referring to an adhesive comprising at least one polyurethane as a binder.

More particularly, the polyurethane adhesive comprises an aqueous polyurethane adhesive; preferably, the aqueous polyurethane adhesive comprises an aqueous solution of a polyurethane or, more preferably, an aqueous dispersion of a polyurethane as a binder.

The polyurethane adhesive, as well as the polyurethane, may comprise further binders, including for example free-radically polymerizable polymers, such as polyacrylates, polyvinyl acetate or ethylene-acetate copolymers, or other additives.

The polyurethane adhesive is preferably altogether at least 15% by weight, preferably at least 30% by weight, more preferably at least 50% by weight, in particular at least 70% by weight or at least 90% by weight polyurethane, based on the sum total of all constituents (solid, i.e., except water and solvents having a boiling point below 150° C. at 1 bar).

In one particular embodiment, the adhesive comprises just a polyurethane or a mixture of polyurethanes as a binder.

The polyurethanes preferably consist predominantly of isocyanates, in particular diisocyanates on the one hand and, as the other reactant, polyester diols, polyether diols or mixtures thereof, on the other.

Diisocyanates, polyether diols and/or polyester diols preferably make up at least 40% by weight, more preferably at least 60% by weight and most preferably at least 80% by weight of the polyurethane.

The melting point of the polyurethane is preferably in the range from −50 to 150° C., more preferably in the range from 20 to 150 and even more preferably in the range from 30 to 100° C. and especially in the range from 50 to 80° C.

Polyester diols are preferably present in the polyurethane in an amount of more than 10% by weight, based on the polyurethane.

Altogether, the polyurethane is preferably constructed from:
a) diisocyanates,
b) diols of which
b1) 10 to 100 mol %, based on the total amount of the diols (b), have a molecular weight in the range from 500 to 5000 g/mol,
b2) 0 to 90 mol %, based on the total amount of diols (b), have a molecular weight in the range from 60 to 500 g/mol,
c) monomers other than the monomers (a) and (b) and having at least one isocyanate group or at least one isocyanate-reactive group and additionally bearing at least one hydrophilic group or potentially hydrophilic group to render the polyurethanes water dispersible,
d) if appropriate further polyfunctional compounds other than the monomers (a) to (c) and having reactive groups comprising alcoholic hydroxyl groups, primary or secondary amino groups or isocyanate groups, and
e) if appropriate monofunctional compounds other than the monomers (a) to (d) and having a reactive group comprising an alcoholic hydroxyl group, a primary or secondary amino group or an isocyanate group.

Useful monomers (a) include in particular diisocyanates X(NCO)₂, where X is an aliphatic hydrocarbyl radical having 4 to 15 carbon atoms, a cycloaliphatic or aromatic hydrocarbyl radical having 6 to 15 carbon atoms or an araliphatic hydrocarbyl radical having 7 to 15 carbon atoms. Examples of such diisocyanates are tetramethylene diisocyanate, hexamethylene diisocyanate, dodecamethylene diisocyanate, 1,4-diiso-cyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-di-isocyanatobenzene, 2,4-diisocyanatotoluene, 2,6-diisocyanatotoluene, 4,4′-diiso-cyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)-methane (HMDI) such as the trans/trans, the cis/cis and the cis/trans isomers and also mixtures thereof.

Diisocyanates of this kind are commercially available.

Useful mixtures of these isocyanates include particularly the mixtures of the respective structural isomers of diisocyanatotoluene and diisocyanatodiphenylmethane in that the mixture of 80 mol % of 2,4-diisocyanatotoluene and 20 mol % of 2,6-diisocyanatotoluene is suitable in particular. Further, the mixtures of aromatic isocyanates such as 2,4-diisocyanatotoluene and/or 2,6-diisocyanatotoluene with aliphatic or cycloaliphatic isocyanates such as hexamethylene diisocyanate or IPDI are particularly advantageous, the preferred mixing ratio of the aliphatic isocyanates to the aromatic isocyanates being in the range from 4:1 to 1:4.

Useful building block components for the polyurethanes, as well as the compounds mentioned above, include isocyanates which, as well as free isocyanate groups, bear further blocked isocyanate groups, for example uretdione groups.

With regard to good filming and elasticity, useful diols (b) chiefly include comparatively high molecular weight diols (b1) which have a molecular weight of about 500 to 5000 and preferably of about 1000 to 3000 g/mol. The molecular weight in question is the number average molecular weight Mn. Mn results from determining the number of end groups (OH number).

The diols (b1) may comprise polyester polyols known for example from Ullmanns Encyklopädie der technischen Chemie, 4th edition, volume 19, pages 62 to 65. Preference is given to using polyester polyols obtained by reaction of dihydric alcohols with dibasic carboxylic acids. Instead of the free polycarboxylic acids, it is also possible to use corresponding polycarboxylic anhydrides or corresponding polycarboxylic esters of lower alcohols or mixtures thereof to prepare the polyester polyols. The polycarboxylic acids may be aliphatic, cycloaliphatic, araliphatic, aromatic or heterocyclic and may if appropriate be substituted, by halogen atoms for example, and/or unsaturated. Examples thereof are suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimeric fatty acids. Preference is given to dicarboxylic acids of the general formula HOOC—(CH2)y-COOH, where y is from 1 to 20 and preferably an even number from 2 to 20, examples being succinic acid, adipic acid, sebacic acid and dodecanedicarboxylic acid.

Useful polyhydric alcohols include for example ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)-cyclohexane, 2-methylpropane-1,3-diol, methylpentanediols, also diethylene glycol, triethylene glycol, tetraethylene glycol, polyethylene glycol, dipropylene glycol, polypropylene glycol, dibutylene glycol and polybutylene glycols. Preference is given to alcohols of the general formula HO—(CH2)x-OH, where x is from 1 to 20, preferably an even number from 2 to 20. Examples thereof are ethylene glycol, butane-1,4-diol, hexane-1,6-diol, octane-1,8-diol and dodecane-1,12-diol. Neopentyl glycol is also preferred.

Also suitable are if appropriate polycarbonate diols as obtainable for example by reaction of phosgene with an excess of the low molecular weight alcohols specified as building block components for the polyester polyols.

Polyester diols based on lactone can also be used if appropriate, in which case they comprise homo- or interpolymers of lactones, preferably terminally hydroxylated addition products of lactones onto suitable difunctional starter molecules. Useful lactones are preferably those derived from compounds of the general formula HO—(CH2)z-COOH, where z is from 1 to 20 and an H atom of a methylene unit may also be replaced by a C1- to C4-alkyl radical. Examples are e-caprolactone, β-propiolactone, g-butyrolactone and/or methyl-e-caprolactone and also mixtures thereof. Useful starter components include for example the low molecular weight dihydric alcohols mentioned above as a building block component for the polyester polyols. The corresponding polymers of e-caprolactone are particularly preferred. Low polyester diols or polyether diols can also be used as starters for preparing the lactone polymers. Instead of the polymers of lactones it is also possible to use the corresponding, chemically equivalent polycondensates of the hydroxy carboxylic acids corresponding to the lactones.

Polyether diols are obtainable in particular by polymerization of ethylene oxide, propylene oxide, butylene oxide, tetrahydrofuran, styrene oxide or epichlorohydrin with itself, for example in the presence of BF3 or by addition of these compounds If appropriate in the mixture or in succession, onto starting components having reactive hydrogen atoms, such as alcohols or amines, for example water, ethylene glycol, propane-1,2-diol, propane-1,3-diol, 2,2-bis(4-hydroxyphenyl)propane or aniline. Particular preference is given to polypropylene oxide, polytetrahydrofuran of molecular weight from 240 to 5000 and in particular 500 to 4500.

The only polyether diols falling within b1) are less than 20% by weight ethylene oxide. Polyether diols having at least 20% by weight are hydrophilic polyether diols, which count as monomers c).

If appropriate, polyhydroxyolefins can be used as well, preferably those having 2 terminal hydroxyl groups, for example α,ω-dihydroxypolybutadiene, α,ω-dihydroxy polymethacrylic ester or α,ω-dihydroxy polyacrylic ester as monomers (c1). Such compounds are known for example from, EP-A 622 378. Further suitable polyols are polyacetals, polysiloxanes and alkyd resins.

Preferably, at least 30 mol % and more preferably at least 70 mol % of the diols b1) comprise polyester diols. It is particularly preferred to use exclusively polyester diols as diols b1).

The hardness and modulus of elasticity of the polyurethanes can be enhanced by using as diols (b) alongside diols (b1) low molecular weight diols (b2) having a molecular weight of about 60 to 500, preferably of 62 to 200 g/mol.

Useful monomers (b2) include in particular the building block components of the short chain alkanediols mentioned for the preparation of polyester polyols, the unbranched diols having 2 to 12 carbon atoms and an even number of carbon atoms and also 1,5-pentanediol and neopentyl glycol being preferred.

Useful diols b2) include for example ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, also diethylene glycol, triethylene glycol, tetraethylene glycol, polyethylene glycol, dipropylene glycol, polypropylene glycol, dibutylene glycol and polybutylene glycols. Preference is given to alcohols of the general formula HO—(CH2)x-OH, where x is from 1 to 20, preferably an even number from 2 to 20. Examples thereof are ethylene glycol, butane-1,4-diol, hexane-1,6-diol, octane-1,8-diol and dodecane-1,12-diol. Neopentyl glycol is also preferred.

Preferably, the fraction of diols (b1) in terms of the total amount of the diols (b) is in the range from 10 to 100 mol % and the fraction of monomers (b2) in terms of the total amount of the diols (b) is in the range from 0 to 90 mol %. It is particularly preferable for the ratio of the diols (b1) to the monomers (b2) to be in the range from 0.1:1 to 5:1 and more preferably in the range from 0.2:1 to 2:1.

To render the polyurethanes water dispersible, they preferably comprise, as a building block component, monomers (c) other than components (a), (b) and (d) and bearing at least one isocyanate group or at least one isocyanate-reactive group and in addition at least one hydrophilic group or at least one group convertible into a hydrophilic group. Hereinbelow, the term “hydrophilic groups or potentially hydrophilic groups” is shortened to “(potentially) hydrophilic groups”. The (potentially) hydrophilic groups react with isocyanates significantly slower than the functional groups of the monomers serving to construct the polymeric backbone.

The fraction of components having (potentially) hydrophilic groups as a proportion of the total amount of the components (a), (b), (c), (d) and (e) is generally determined such that the molar amount of the (potentially) hydrophilic groups in terms of the weight of all monomers (a) to (e) is in the range from 30 to 1000 mmol/kg, preferably in the range from 50 to 500 mmol/kg and more preferably in the range from 80 to 300 mmol/kg.

The (potentially) hydrophilic groups may comprise nonionic or preferably (potentially) ionic hydrophilic groups.

Useful nonionic hydrophilic groups include in particular polyethylene glycol ethers composed of preferably 5 to 100 and more preferably 10 to 80 ethylene oxide repeat units. The level of polyethylene oxide units is generally in the range from 0% to 10% by weight and preferably in the range from 0% to 6% by weight, all based on the weight of all monomers (a) to (e).

Preferred monomers having nonionic hydrophilic groups are polyethylene oxide diols comprising at least 20% by weight of ethylene oxide, polyethylene oxide monools and also the reaction products of a polyethylene glycol and a diisocyanate which bear a terminally etherified polyethylene glycol radical. Such diisocyanates and their methods of making are specified in the patent specifications U.S. Pat. No. 3,905,929 and U.S. Pat. No. 3,920,598.

Ionic hydrophilic groups are in particular anionic groups such as the sulfonate group, the carboxylate group and the phosphate group in the form of their alkali metal or ammonium salts and also cationic groups such as ammonium groups, in particular protonated tertiary amino groups or quaternary ammonium groups.

Potentially ionic hydrophilic groups are in particular those which are convertible by simple neutralizing, hydrolyzing or quaternizing reactions, into the abovementioned ionic hydrophilic groups, i.e., for example carboxylic groups or tertiary amino groups.

(Potentially) ionic monomers (c) are described at length for example in Ullmanns Encyklopädie der technischen Chemie, 4th edition, volume 19, pages 311-313 and for example in DE-A 1 495 745.

(Potentially) cationic monomers (c) of particular practical importance are in particular monomers having tertiary amino groups, examples being: tris(hydroxyalkyl)amines, N,N′-bis(hydroxyalkyl)alkylamines, N-hydroxyalkyldialkylamines, tris(aminoalkyl)-amines, N,N′-bis(aminoalkyl)alkylamines, N-aminoalkyldialkylamines, the alkyl radicals and alkanediyl units of these tertiary amines consisting independently of 1 to 6 carbon atoms. Polyethers having tertiary nitrogen atoms and preferably two terminal hydroxyl groups, as obtainable in a conventional manner for example by alkoxylation of amines having two hydrogen atoms attached to amine nitrogen, examples being methylamine, aniline or N,N′-dimethylhydrazine, are also suitable. Such polyethers generally have a molecular weight between 500 and 6000 g/mol.

These tertiary amines are converted into the ammonium salts either with acids, preferably strong mineral acids such as phosphoric acid, sulfuric acid, halohydric acids or strong organic acids, or by reaction with suitable quaternizing agents such as C1- to C6-alkyl halides or benzyl halides, examples being bromides or chlorides.

Useful monomers having (potentially) anionic groups typically include aliphatic, cycloaliphatic, araliphatic or aromatic carboxylic acids and sulfonic acids which bear at least one alcoholic hydroxyl group or at least one primary or secondary amino group. Preference is given to dihydroxyalkylcarboxylic acids, in particular of 3 to 10 carbon atoms, as also described in U.S. Pat. No. 3,412,054. Preference is given in particular to compounds of the general formula (c1)

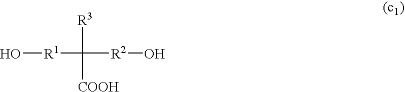

where R1 and R2 are each a C1- to C4-alkanediyl (unit) and R3 is a C1- to C4-alkyl (unit), and in particular dimethylolpropionic acid (DMPA).

The corresponding dihydroxy sulfonic acids and dihydroxy phosphonic acids such as 2,3-dihydroxypropanephosphonic acid are also suitable.

Otherwise suitable are dihydroxy compounds having a molecular weight above 500 to 10 000 g/mol and at least 2 carboxylate groups, which are known from DE-A 39 11 827. They are obtainable by reaction of dihydroxy compounds with tetracarboxylic dianhydrides such as pyromellitic dianhydride or cyclopentanetetracarboxylic dianhydride in a molar ratio in the range from 2:1 to 1.05:1 in a polyaddition reaction. Useful dihydroxy compounds include in particular the monomers (b2) recited as chain extenders and also the diols (b1).

Useful monomers (c) having isocyanate-reactive amino groups include amino carboxylic acids such as lysine, β-alanine or the adducts of aliphatic diprimary diamines onto α,β-unsaturated carboxylic or sulfonic acids that are mentioned in DE-A 20 34 479.

Such compounds conform for example to the formula (c2)

H₂N—R⁴—NH—R⁵—X (c2)

where
R⁴ and R⁵ are independently a C1- to C6-alkanediyl unit, preferably ethylene

### and X is COOH or SO₃H.

Particularly preferred compounds of the formula (c2) are N-(2-aminoethyl)-2-aminoethanecarboxylic acid and also N-(2-aminoethyl)-2-aminoethanesulfonic acid and the corresponding alkali metal salts, wherein sodium is particularly preferred as counter-ion.

Particular preference is further given to adducts of the abovementioned aliphatic diprimary diamines onto 2-acrylamido-2-methylpropanesulfonic acid, as are described for example in DE-B 1 954 090.

When monomers having potentially ionic groups are used, their conversion into the ionic form can take place before, during but preferably after the isocyanate polyaddition, since ionic monomers are frequently only sparingly soluble in the reaction mixture. It is particularly preferable for the sulfonate or carboxylate groups to be present in the form of their salts with an alkali metal ion or an ammonium ion as counterion.

The monomers (d) other than monomers (a) to (c) and also if appropriate constituents of the polyurethane generally serve to crosslink or to chain extend. They are generally more than dihydric nonphenolic alcohols, amines having 2 or more primary and/or secondary amino groups and also compounds which, as well as one or more alcoholic hydroxyl groups, bear one or more primary and/or secondary amino groups.

Alcohols having a higher hydricness than 2, which can be used to set a certain degree of branching or crosslinking, are for example trimethylolpropane, glycerol or sugar.

It is further possible to use monoalcohols which, as well as the hydroxyl group, bear a further isocyanate-reactive group, such as monoalcohols having one or more primary and/or secondary amino groups, an example being monoethanolamine.

Polyamines having 2 or more primary and/or secondary amino groups are used in particular whenever the chain extension or crosslinking is to take place in the presence of water, since amines generally react faster with isocyanates than alcohols or water do. This is frequently necessary whenever aqueous dispersions of crosslinked polyurethanes or polyurethanes of high molecular weight are desired. In such cases, the procedure is to prepare prepolymers having isocyanate groups, to disperse them rapidly in water and then to chain extend or crosslink them by addition of compounds having a plurality of isocyanate-reactive amino groups.

Amines suitable for this purpose are generally polyfunctional amines of the molecular weight range 32 to 500 g/mol and preferably 60 to 300 g/mol, which comprise at least two amino groups selected from the group of the primary and secondary amino groups. Examples thereof are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane.

The amines can also be used in blocked form, for example in the form of the corresponding ketimines (see for example CA-A 1 129 128), ketazines (cf. for example the U.S. Pat. No. 4,269,748 document) or amine salts (see U.S. Pat. No. 4,292,226). Similarly, oxazolidines as used for example in U.S. Pat. No. 4,192,937 constitute blocked polyamines which can be used for the preparation of the polyurethanes of the present invention to chain extend the prepolymers. When such blocked polyamines are used, these are generally mixed with the prepolymers in the absence of water and this mixture is subsequently mixed with the dispersion water or a portion of the dispersion water, so that the corresponding polyamines are released by hydrolysis.

Preference is given to using mixtures of di- and triamines, preferably mixtures of isophoronediamine (IPDA) and diethylenetriamine (DETA).

The polyurethanes comprise preferably 1 to 30 and more preferably 4 to 25 mol %, based on the total amount of the components (b) and (d), of a polyamine having at least 2 isocyanate-reactive amino groups as monomers (d).

Monomers (d) higher than difunctional isocyanates can also be used for the same purpose. Commercially available compounds are for example the isocyanurate or the biuret of hexamethylene diisocyanate.

Monomers (e), which are used if appropriate, are monoisocyanates, monoalcohols and monoprimary and -secondary amines. In general, their fraction is not more than 10 mol %, based on the total molar amount of the monomers. These monofunctional compounds typically bear further functional groups such as olefinic groups or carbonyl groups and serve to introduce functional groups into the polyurethane which enable the polyurethane to be dispersed or crosslinked or partake in further polymer-analogous conversion. Monomers useful for this purpose are such as isopropenyl-a,a-dimethylbenzyl isocyanate (TMI) and esters of acrylic or methacrylic acid such as hydroxyethyl acrylate or hydroxyethyl methacrylate.

Coatings having a particularly good performance profile are obtained in particular when using, as monomers (a), essentially only aliphatic diisocyanates, cycloaliphatic diisocyanates or araliphatic diisocyanates.

This combination of monomers is superbly complemented, as component (c), by diaminosulfonic acid-alkali metal salts; very particularly by N-(2-aminoethyl)-2-aminoethanesulfonic acid or its corresponding alkali metal salts, of which the sodium salt is most suitable, and a mixture of DETA/IPDA as component (d).

The way to adjust the molecular weight of the polyurethanes through choice of the fractions of the mutually reactive monomers and of the arithmetic mean of the number of reactive functional groups per molecule is common general knowledge in the field of polyurethane chemistry.

Normally, components (a) to (e) and also their respective molar quantities are chosen so that the ratio A:B where
A is the molar amount of isocyanate groups and
B is the sum total of the molar amount of hydroxyl groups and the molar amount of functional groups capable of reacting with isocyanates in an addition reaction
   is in the range from 0.5:1 to 2:1, preferably in the range from 0.8:1 to 1.5, and more preferably in the range from 0.9:1 to 1.2:1. It is very particularly preferable for the A:B ratio to be very close to 1:1.

The monomers (a) to (e) used bear on average typically 1.5 to 2.5, preferably 1.9 to 2.1 and more preferably 2.0 isocyanate groups or functional groups capable of reacting with isocyanates in an addition reaction.

The polyaddition of components (a) to (e) to produce the polyurethane is preferably effected at reaction temperatures of up to 180° C. and preferably up to 150° C. under atmospheric pressure or under autogenous pressure.

The production of polyurethanes and of aqueous polyurethane dispersions is known to one skilled in the art.

The polyurethane adhesive can consist exclusively (apart from water and solvent) of the polyurethane as a binder. But it may also comprise further additives, for example fillers, thickeners, defoamers, etc.

Also suitable are in particular crosslinkers, for example compounds having carbodiimide groups, isocyanate groups or aziridine groups.

The crosslinkers may also be in a state of attachment to polymers, for example to the aforementioned polymeric binders.

The polyurethane adhesive may comprise a one component (1K) or a two component (2K) adhesive.

In the case of a 1K adhesive, no further component is added before use.

In the case of a 2K adhesive, a further component, a crosslinker for example, is added shortly before use; after addition of the further components, a crosslinking reaction ensues in the case of a 2K adhesive, so that processing absolutely has to take place soon.

Crosslinkers for 2K adhesives are for example crosslinkers having isocyanate groups.

Compounds having carbodiimide groups are preferred for use as crosslinkers, since aqueous dispersions comprising such compounds, or to be more precise carbodiimide groups, are stable in storage, i.e., can be used like 1K adhesives.

Preference is given to polyurethane adhesives comprising a crosslinker (either as an additive or attached to the polyurethane).

1K polyurethane adhesives are particularly preferred.

The preference is in particular for polyurethane adhesives which result in nonblocking, i.e., nontacky, coatings at room temperature (20° C.) after drying. The dried coatings of adhesive will provide adhesive bonds of unchanged high strength even after several weeks, for example after more than 4 or more than 8 weeks. In the case of the (later) use, these coatings of polyurethane are warmed and are then tacky.

Polyurethane adhesives having these properties are in particular those which partly or exclusively comprise polyesters as diols (b1) (see above), or those which have a melt enthalpy of more than 20 J/g in the temperature range from 20 to 150° C. and preferably in the temperature range from 30 to 100° C.

Melting point and melt enthalpy are measured by the method of differential scanning calorimetry.

The measurement is carried out on polyurethane films 200 μm in thickness, which were dried in a circulating air drying cabinet at 40° C. for 72 hours before measurement. To prepare the measurement, about 13 mg of the polyurethane are filled into crucibles. The crucibles are sealed, the samples are heated to 120° C., cooled at 20 K/min and kept at 20° C. for 20 hours. The samples thus prepared are measured by the DSC method of DIN 53765, the sample being heated at 20 K/min. The melting temperature is the peak temperature as per DIN 53765, and the melt enthalpy is determined as in FIG. 4 of DIN 53765.

### The Composited Element

The composited element of the present invention comprises a substrate composed of a polyolefin (polyolefin substrate) and a substrate composed of a polyurethane (polyurethane substrate) which are composited together by an adhesive. The composited elements can consist solely of these two substrates, but they may also comprise any desired further substrates.

The polyolefin substrate and the polyurethane substrate may each have any desired form. More particularly, the substrates may be films, fibrous webs, plates, plaques, sheets, slabs or any other shaped articles.

More particularly, the substrates comprise films of polymer or fibrous webs. The two substrates may comprise two polymeric films or two fibrous webs, but they may also comprise one fibrous web and one polymeric film, which are composited together.

The fibrous web may comprise not only the polyolefin substrate but also the polyurethane substrate; correspondingly, the polymeric film may comprise the polyolefin substrate or else the polyurethane substrate.

More preferably, the composited element comprises a fibrous web composited to a polymeric film or to another fibrous web by an adhesive.

In one preferred embodiment, the polyolefin substrate comprises a fibrous web and the polyurethane substrate comprises a polymeric film.

In one further preferred embodiment, not only the polyolefin substrate but also the polyurethane substrate each comprise a fibrous web.

### The Fibrous Web

The fibrous web preferably comprises a web composed of non-woven fibers.

Webs can be produced in two ways. To produce a non-woven fibrous web, fibers are for example laid together to form some structure and are consolidated by different processes to form a coherent fibrous web. For instance, the web is treated with an aqueous binder, for example a polymer latex, and subsequently, if appropriate after removal of excess binder, dried and if appropriate cured.

In the case of the polymer-to-web processes, the webs are directly processed from the substrates to form the fibrous webs. These processes include the well-known meltblown processes or spunbond processes. Meltblown processes and spunbond processes are known in the art. The nonwovens they produce generally differ in their mechanical properties and their consistency. Nonwovens produced by the spunbond process are particularly stable not only in the horizontal direction but also in the vertical direction, but also have an open-pore construction.

Nonwovens produced by the meltblown process have a particularly dense network of fibers and hence form a very good barrier to liquids.

A commercial plant for producing nonwovens can be used for producing a nonwoven by the polymer-to-web processes.

Described schematically, the polymer-to-web process typically involves the polymeric substrate being melted in an extruder and fed by means of customary ancillaries such as melt pumps or filters to a spinning manifold. Here, the polymer generally flows through nozzles and, at the nozzle exit, is attenuated to form a filament. The attenuated filaments are typically laid down on a drum or belt and forwarded.

In one preferred embodiment, the material is to be regarded as a nonwoven for the purposes of this invention when more than 50% and in particular 60% to 90% of the mass of its fibrous constituent consists of fibers having a length to diameter ratio of more than 300 and in particular of more than 500.

In one preferred embodiment, the individual fibers of the nonwoven have a diameter in the range from 50 μm to 0.1 μm, preferably in the range from 10 μm to 0.5 μm and especially in the range from 7 μm to 0.5 μm.

In one preferred embodiment, the nonwovens have a thickness in the range from 0.01 to 5 millimeters (mm) and more preferably in the range from 0.1 to 2 mm, measured to ISO 9073-2.

In one preferred embodiment, the nonwovens have a weight per unit area in the range from 5 to 2000 g/m², more preferably in the range from 5 to 500 g/m² and especially of 10-150 g/m², measured to ISO 9073-1.

The nonwoven may additionally be mechanically consolidated. Mechanical consolidation may take the form of one-sided or both-sided mechanical consolidation; two-sided mechanical consolidation is preferred.

In addition to the aforedescribed mechanical consolidation, the nonwoven may further be thermally consolidated. Thermal consolidation may be effected for example by subjecting the nonwoven to treatment with hot air.

The following remarks apply to the polymeric film, which is preferably a polyurethane film, in general:

The polymeric film has, preferably, a thickness of 1 μm to 1000 μm, preferably 10μ-100 μm, or has a basis weight of 1 g/m²-1000 g/m², preferably in the range from 10 g/m² to 100 g/m² and more preferably in the range from 10 g/m² to 30 g/m².

The polyolefin substrate and the polyurethane substrate are composited together by an adhesive, preferably a polyurethane adhesive. The polyurethane adhesive may comprise in particular an aqueous polyurethane adhesive, preferably a polyurethane adhesive comprising an aqueous polyurethane dispersion as a binder.

The adhesive can be applied to one of the two substrates to be adhered together, or to both the substrates.

Coating can be effected according to customary methods. Coating is followed, if appropriate, by a drying step, preferably at room temperature or temperatures up to 80° C., to remove water or other solvents.

The amount of adhesive used is preferably in the range from 0.5 to 100 g/m², more preferably in the range from 2 to 80 g/m² and most preferably in the range from 10 to 70 g/m², irrespective of whether just one substrate or both the substrates were coated.

When adhesives having carbodiimides as a crosslinker are used, the coated and dried substrates can be stored. Flexible substrates can be wound up on drums.

To adhere the two substrates, for example the polypropylene fibrous web and the polyurethane film, they are joined together. This can also be done in a continuous operation.

The substrates are preferably pressed together.

The temperature in the layer of adhesive is preferably in the range from 20 to 200° C. and more preferably in the range from 30 to 180° C. Suitably, the adhesive-coated substrate is warmed/heated to appropriate temperatures.

Adhering preferably takes place under pressure in that, for instance, the parts to be adhered together can be pressed together using a pressure in the range from 0.05 to 5 N/mm².

The composited element obtained is simple to produce and has the requisite properties for the particular use.

The method of making involves in particular no physical pretreatment of the surfaces to be adhered together, for example no electrostatic treatment by corona or plasma discharge. Similarly, there is no need for any chemical pretreatment, for example no need to use adhesion promoters or primers.

In one preferred version of its method of making, the composited element is produced continuously in-line. When the composited element comprises for example a composited element composed of a polyolefin web and a TPU web, the polyolefin web can be produced by one of the processes described above, for example by a polymer-to-web process, for example by the spunbond process, and laid down on a continuous belt. The adhesive is then applied to the polyolefin web. In a further step, the polyurethane web is applied by a polymer-to-web process, for example a meltblown process, directly to the polyolefin web comprising the adhesive.

When the composited element comprises for example a composited element composed of a polyolefin web and a TPU film, the polyolefin web can be produced by one of the processes described above, for example a polymer-to-web process, for example by the spunbond process, and laid down on a continuous belt. The adhesive is then applied to the polyolefin web. In a further step, the polyurethane film is extruded directly onto the polyolefin web comprising the adhesive.

Such in-line processes make for high productivity in the manufacture of the composited elements.

Composited elements, or laminates composed of fibrous webs, in particular polypropylene fibrous webs, and polymeric films, in particular polyurethane films, are very useful as roofing underlayments.

When used as a roofing underlayment, the composited element, or laminate, shall have in particular good mechanical properties coupled with the requisite breathability. The laminate shall be obtainable and usable in an easy and environmentally friendly manner.

The laminate obtained is notable for high mechanical strength, in particular a high breaking strength, at elevated temperatures (heat resistance) or under greatly varying climatic conditions (climatic resistance). The laminate has very good tightness to liquid water, but also has a high water vapor permeability. The laminate or roofing underlayment preferably has an overall thickness in the range from 1 μm to 6 mm.

Roofing underlayments are used for sealing roof trusses against penetrating water, but they must also be pervious to water vapor and have the necessary mechanical breaking strength. Roofing underlayments are generally stretched over the wooden frame of a roof truss.

Further composited elements and uses of composited elements are:

composited elements composed of polyolefin web and TPU web. These laminates are elastic in character, provide a comfortable wear comfort and are particularly useful for hygiene articles, for example diapers and other incontinence products, for clothing articles, for example disposable underwear, T-shirts, and also applications in the medical sector, for example bandages and plasters.

### EXAMPLES

Polyurethane adhesives used:

### Adhesive 1

### Polyurethane Dispersion:

750 g of a polyester formed from adipic acid and 1,4-butanediol (OH number=45), 0.25 g of DBTL (dibutyltin dilaurate) and 13.4 g of dimethylolpropionic acid were reacted in 100 g of acetone with 112.3 g of IPDI at 90° C. for 3 h 37 min. This was followed by diluting with 900 g of acetone and cooling down to 50° C. The NCO content was 0.55%. 9 g of triethylamine were added and stirred in for 5 min, at which point 5 g of NCO-terminated polycarbodiimide of tetramethylxylylene diisocyanate with 8% NCO and 15% carbodiimide groups were added and stirred in for 1 min. This was followed by chain extension with 37.4 g of a 50% aqueous solution of the sodium salt of aminoethylaminoethanesulfonic acid and 40 g of completely ion-free water. After 4 min, a dispersion was formed with 1200 g of completely ion-free water. The acetone was distilled off at temperatures up to 43° C. under reduced pressure and the solids content was adjusted to 40%.

Analytical values: viscosity 152 mPas, K value 56, pH 7.5.

Basonat® DS 3582: carbodiimide crosslinker

The Basonate was added to the polyurethane dispersion in an amount of 2.5 parts by weight per 100 parts by weight of polyurethane (solid/solid). The mixture can be used as a one component (1K) adhesive.

### Adhesive 2

### Luphen®D 200A:

commercially available aqueous polyurethane dispersion for adhesives, polyurethane synthesized using a polyester diol.

### Adhesive 3

### Polyurethane Dispersion:

600 g of pTHF 2000 (poly-tetrahydrofuran) were reacted with 40.2 g of DMPA and 0.1 g of TBOT (tetrabutyl orthotitanate) in 100 g of acetone with 133.4 g of IPDI at 100° C. for 4 h. This was followed by diluting with 900 g of acetone and cooling down to 50° C. The NCO content was 0.18%. 10.1 g of triethylamine were added and stirred in for 5 min, at which point 6.5 g of isophoronediamine in 20 g of completely ion-free water were added and stirred in until the increase in the viscosity had ceased. A dispersion was then formed with 750 g of completely ion-free water. The acetone was distilled off at temperatures up to 43° C. under reduced pressure and the solids content was adjusted to 50%.

Analytical values: viscosity 200 mPas, K value 45, pH 7.5.

Basonat® F 200WD: polyisocyanate crosslinker

The Basonate was added to the polyurethane dispersion in an amount of 12.5 parts by weight per 100 parts by weight of polyurethane (solid/solid). The mixture can be used as a two component (2K) adhesive, i.e., the crosslinker is added not until shortly before processing.

### Production of Laminates

A polypropylene fiber web and a film composed of thermoplastic polyurethane (TPU) were adhered together.

To this end, 60 g of the above adhesive were coated onto 1 m2 of TPU and 75 g of the above adhesive onto the polypropylene fiber web.

Adhering was done by two different methods:

wet/wet: the coating was applied to both the substrates using a 1 mm doctor, the two substrates were laid together wet and passed through a dryer at 95° C.
dry/dry: the coating was applied to both the substrates using a 1 mm doctor. Thereafter, the two substrates were dried at room temperature for 1 hour, in the course of which the polyester-containing adhesives 1 and 2 resulted in coatings which were nonblocking, i.e., nontacky, at room temperature. This was followed by pressing together at 90° C. and a pressure of 0.5 N/mm² for 30 seconds.

### Performance Testing

The peel strength of the laminates was then determined. To this end, the TPU film was peeled off in a tensile tester at a 180° angle and the force required was determined in N/5 cm.

Results are reported in the table:

| Adhesive | Method | Peel strength |
|---|---|---|
| Adhesive 1 | wet/wet | 21 |
| Adhesive 1 | dry/dry | 26 |
| Adhesive 2 | wet/wet | 1.5 |
| Adhesive 2 | dry/dry | 5 |
| Adhesive 3 | wet/wet | 15 |
| Adhesive 3 | dry/dry | 16 |

1. A composited element comprising a substrate composed of a polyolefin and a substrate composed of a polyurethane which are composited together by an adhesive.

2. The composited element according to claim 1 wherein said polyurethane comprises thermoplastic polyurethane (TPU).

3. The composited element according to claim 1 wherein said substrates both comprise a polymeric film or a fibrous web or said substrates comprise respectively a fibrous web and a polymeric film.

4. The composited element according to claim 1 which comprises a fibrous web composed of polyolefin fibers and a polyurethane film which are composited together by an adhesive.

5. The composited element according to claim 1 which comprises a fibrous web composed of polyolefin fibers and polyurethane fibers which are composited together by an adhesive.

6. The composited element according to claim 4 wherein said fibrous web is composed of polypropylene fibers.

7. The composited element according to claim 3 wherein the fibers have a thickness in the range from 0.1 μm to 50 μm.

8. The composited element according to claim 3 wherein said fibrous web has a thickness in the range from 0.01 mm to 5 mm or a basis weight in the range from 5 g/m² to 2000 g/m².

9. The composited element according to claim 3 wherein the thickness of said polymeric film is in the range from 1 μm to 1000 μm.

10. The composited element according to claim 1 wherein said two substrates are composited together by a polyurethane adhesive.

11. The composited element according to claim 1 which is obtainable by using an aqueous polyurethane adhesive.

12. The composited element according to claim 1 which is obtainable by using an adhesive comprising an aqueous polyurethane dispersion as a binder.

13. The composited element according to claim 1 in the form of a laminate having an overall thickness in the range from 1 μm to 6 mm.

14. A roofing underlayment comprising the laminate according to claim 13.
